(19) United States
(12) Patent Application Publication
(10) Pub. No.: US 2003/0110092 A1
(43) Pub. Date: Jun. 12, 2003

(54) Cost-controlled activation of a motor vehicle

(76) Inventor: Robert M. Riegler, Bohl-Iggelheim (DE)

Correspondence Address: David S Sarisky, Fulwider Patton Lee & Utecht, Tenth Floor, 6060 Center Drive, Los Angeles, CA, 90045, US

(21) Appl. No.: 10/204,796

(22) PCT Filed: Feb. 22, 2001
(86) PCT No.: PCT/DE01/00686

(30) Foreign Application Priority Data
Feb. 23, 2000 (DE) 100 08 352.8

(51) Int. Cl. G06F 17/60

(52) U.S. Cl. 705/26

(57) ABSTRACT

The invention is directed to a motor vehicle with a system for cost-managed startup. The system includes a first data transmission unit for the transmission of data from the motor vehicle to at least one receiving station, and a second data transmission unit that links an instrument for measuring the distance covered by the motor vehicle with the first data transmission unit. The first data transmission unit is provided with a transmitting function and is so designed that data can be transmitted from the vehicle via the transmitting function to the receiving station in a wireless manner continually or at predetermined intervals. The data can then be processed in a central station that is connected with the receiving station.

### RELATED APPLICATIONS

This application claims the benefit of PCT International application Serial No. PCT/DE01/00686, filed Feb. 22, 2001 which claims the benefits of German application Serial No. DE 100 352.8, filed Feb. 23, 2000.

### BACKGROUND OF THE INVENTION

1. Field of the Invention

The invention generally relates to a motor vehicle with a system for cost-managed startup, and more particularly relates to a process for individually acquiring the costs of a ride in a motor vehicle.

2. Description of the Related Art

A majority of motor vehicles today are used for both private and business purposes. When used for business purposes, in the case of company vehicles for example, the vehicles are frequently used by different drivers. Moreover, “car-sharing,” i.e., the joint use of a vehicle by several private persons with corresponding cost sharing, is becoming increasingly widespread. In these arrangements, one frequently encounters the question as to which trips are to be matched up with which type of utilization, e.g., private or business purpose, or with which user. The inquiry is relevant especially when costs are to be allocated in accordance with the causal agent.

To solve the problem, one usually employs a driver's daily logbook, which can possibly be connected mechanically or electronically with the tachometer of the vehicle. Using these traditional drivers' logbooks, however, is rather involved and awkward. The data acquired are easily manipulated and the analysis of the acquired data for a particular purpose is awkward and laborious. For instance, the determination of the causally related costs or the match-up with private or business activity, as a rule, requires manual transfer of data into tables or other compilations.

In the motor vehicle of German Patent Application Laid Open to Inspection 199 34 327, the data concerning the distance covered are matched up with the driver and these data are wirelessly transmitted to a central data processing unit. However, at that point in time, there cannot be cost accounting. Instead, the costs must be charged against the driver and must then be processed and collected externally. This simplifies the acquisition of the vehicle's movement, but it does not permit any flexible use of the vehicle by several drivers without a need for an increased accounting effort.

German Patent Application Laid Open to Inspection 41 29 148 discloses an electronic driver's daily logbook. This driver's daily logbook offers the advantage that it can be used to automatically record data concerning the distance covered, which are later manually analyzed or are read into an external computer via customary data-carrier exchange and can be further processed there, but it is the driver himself who must initiate or perform the actual preparation and supply of the data. This means that monitoring or perhaps even automatic cost acquisition or accounting thus cannot be done in any better way than with the old traditional driver's daily logbook.

Hence, those skilled in the art have recognized a need for providing a motor vehicle equipped with a device for cost-managed startup while individually acquiring the costs of a ride in the vehicle. The invention fulfills these needs and others.

### SUMMARY OF THE INVENTION

Briefly, and in general terms, the invention is directed to a motor vehicle with a system for cost-managed startup. In one configuration, the system includes a first data transmission unit for the transmission of data from the motor vehicle to at least one receiving station, and a second data transmission unit that links an instrument for measuring the distance covered by the motor vehicle with the first data transmission unit. The first data transmission unit is provided with a transmitting function and is so designed that data can be transmitted from the vehicle via the transmitting function to the receiving station in a wireless manner continually or at predetermined intervals. The data can then be processed in a central station that is connected with the receiving station.

In another configuration, the system relates to a process for individually acquiring the cost of a ride in a motor vehicle. This process is used to determine the distance covered by the driver. The data comprising the distance covered and possibly additional data such as the identity of the driver are transmitted to the first data transmission unit. The data is also transmitted from the second data transmission unit to the receiving station, and from there to the central station where the specifically user-related costs, generated by covering the particular distance, are calculated and stored.

In one aspect, the invention provides a cost-managed startup system for use in a motor vehicle that facilitates easy accounting of driving costs. The easy accounting is facilitated by providing the motor vehicle with a cost legitimizer made up of a reading unit for credit proof to be submitted by the driver. A release switching action associated with the cost legitimizer makes the vehicle ready for starting only after a positive examination of the credit proof.

In another aspect, the invention provides a process where the cost of a trip taken by the motor vehicle can be determined and where the authorization for going on the trip can be made to depend upon a cost allocation schedule. The costs are deducted from a credit account of the driver and the motor vehicle is made ready for startup only when the costs are covered by the credit account.

These and other aspects and advantages of the invention will become apparent from the following detailed description.

### DETAILED DESCRIPTION OF THE PREFERRED EMBODIMENTS

The invention is directed to a motor vehicle with a system for cost-managed startup. The system includes a first data transmission unit for the transmission of data from the motor vehicle to at least one receiving station, and a second data transmission unit that links an instrument for measuring the distance covered by the motor vehicle with the first data transmission unit. The first data transmission unit is provided with a transmitting function and is so designed that data can be transmitted from the vehicle via the transmitting function to the receiving station in a wireless manner continually or at predetermined intervals. The data can then be processed in a central station that is connected with the receiving station.

The system transmits data as to the distance covered by a motor vehicle to one or several receiving stations. Here it is advantageous to use established mobile radio communication networks, that is to say, the trip data can be transmitted via changing primary receiving stations to a central receiving station where the data are acquired and analyzed. If cost generator-related match-up and accounting of vehicle costs is desired, then the accounting can also be done in a similar manner as the mobile telephone costs: Instead of the number of conversation units, one can, according to the invention, add up the kilometers covered by the unit of cost and that can be the foundation for the accounting function.

As first data transmission unit for this kind of embodiment, one would recommend a customary mobile telephone or a simplified instrument where data can merely be sent out but cannot be received. Suitable modules, for instance, are GSM (Global System for Mobile Communication) or UMTS (Universal Mobile Telecommunication System). For a simple embodiment of the device according to the invention where only the distance covered—possibly also data as to the point of departure and destination or as to the driver—are transmitted to a stationary receiving station, all one needs is the transmitting function. A receiving function, however, facilitates additional advantageous possibilities of practical use of this device.

It is, for example, possible to release the vehicle from the central station only for certain types of uses or certain drivers. This makes it possible to lock the vehicle up in case of nonpayment of leasing fees, especially in leased vehicles. Theft protection is also possible in this way: The vehicle is released at the start of the trip only to the authorized driver who has identified himself by a suitable identity check, e.g., chip card, input code or the like. In case of unauthorized startup, the vehicle, on the other hand, is locked up from the central control unit, that is to say, the identification of the authorized driver is the prerequisite for making the motor vehicle ready for startup.

An advantageous embodiment of the system therefore is characterized in that the first data transmission unit has both a transmitting and a receiving function.

As second data transmission unit of the system, one can, in particular, consider two embodiments. A simpler embodiment is characterized by the following: The second data transmission unit constitutes a connection between the kilometer counter (odometer) of the motor vehicle and the first data transmission unit. The odometer itself in this embodiment need not necessarily be a component of the system, it merely needs to be able to relay the distance data to the device in a suitable form, that is to say, as a rule, in the electronic form. In this way, naturally, only the distance covered can be transmitted; but that may suffice to meet many requirements.

But the mere documentation of the distance covered at a certain point in time often is not sufficient as such, especially when evidence is to be supplied later as to whether a trip was of a private or business nature. For this type of proof, on the other hand, a documented indication as to the destination of the trip, possibly also as to the route chosen, is very nicely suitable. These data can be acquired in a particularly exact manner using a Global Positioning System (GPS) system. For that case, the second data transmission unit thus represents a connection between the first data transmission unit and a GPS system. This GPS system can be combined as an independent unit with the system. But it can advantageously also be integrated into the device. The distances counted and/or the precise location of the vehicle is determined via the GPS system.

If the system is to be used for differentiation between private and business trips, then it is advantageous when the driver, even before the particular trip, determines whether the trip falls within the private or the business category. This determination, for example, can also be made in that the driver manually puts a corresponding information item into the unit. For this purpose, the device can be equipped with a corresponding selection button or the like. But the following is also conceivable: The driver has differing identity cards or codes for the particular type of practice use or the identity card can be inserted into the unit with differing orientations.

Data transmission can basically be continual. Due to the attendant costs, however, intermittent transmission of data is advantageous. Transmission of data only at the time the trip is started and at the time the trip is ended is particularly advantageous. When data are also to be transmitted as to the route or stops during the trip, then it is advantageous first of all to store those data and to transmit the cumulative trip data at the end of the trip or at the end of a day or at the end of some other unit of time to the central station. In order not to record every stop during the trip as the end of the trip, the device can also be so designed that the end of the trip is put in manually as such by means of a corresponding input or that only the renewed input of the identity card or the safety code will mark a new trip with a correspondingly new accounting function.

Along with the distance covered, the trip time is another important parameter that is to be documented. It is therefore advantageous to have a system which additionally contains a radio clock or a connection with a radio clock. In contrast to clocks that can be adjusted in a decentralized manner, the radio clock offers the advantage that it cannot be manipulated by the user. The radio clock, for example, can be in the vehicle itself, for example, in the device itself. But it is also conceivable that the time can be recorded in the stationary receiving station. This embodiment presupposes that the data must be sent out each time at the start and the end of the trip.

For purposes of driver identification, the system can contain a device for identifying the motor vehicle's driver. Several embodiments are conceivable for this identification module. For example, the driver can be identified by putting in a code. Particularly advantageous and even more secure is a device where the driver identification is a device for receiving an identity card. As identity cards, one can consider, for example, the usual chip cards or magnetic strip cards. Instruments for receiving such chip or magnetic strip cards, in other words, reading units for such identity cards, are in wide use and are well known. If desired, the identity check can also require a combination of identity card and code input as in the case of credit cards.

A particularly advantageous device in line with the invention at hand is characterized by the following: As first data transmission unit (A), it contains a GSM or UMTS module, as distance counter, it contains a GPS system, and as driver identification, it contains a device for receiving an identity card. The individual components of this particularly advantageous embodiment are known to those skilled in the art and are commercially available in many different versions. The connection of the individual components to the system does not require any special knowledge or data that would go beyond the general knowledge of those skilled in the art.

The system, especially the embodiment that earlier is described as being particularly advantageous, should be so designed that the following data can be transmitted from the motor vehicle to the central station: When starting the trip after checking the legitimization of the driver and possibly after the vehicle has been switched clear by the central station, the date, the clock time, the exact location (possibly specifying the street location), the kilometer count as well as an indication by the driver as to whether this is a private or business trip should be capable of being transmitted. At the end of the trip, it should again be possible to acquire the date, clock time, exact location (street) and distance, and it should be possible to transmit these data.

Given in its simplest form, the device described meets all requirements for an electronic daily driver's log. Particularly advantageous, however, is the use of the device for cause-related match-up of motor vehicle costs, for example, in case of car sharing as well as for manipulation-proof documentation of trip data regarding the proof as to business or private use such as it is required, for example, by tax authorities.

The transmission of the data to a central data station, in particular, via the Internet, is advantageous in addition to the possibility of transmitting trip data to a mobile radio receiving station. The first data transmission unit must be capable of transmitting data to the Internet. Here one might, for example, think of using an Internet-capable mobile phone or a similar unit that has this capability. When the Internet is used for relaying trip data, it is also possible, along with cost match-up and accounting, to perform an identification of the driver and possibly to clear the motor vehicle after the driver's identity data have been checked out.

Another great advantage of the system cost acquisition and accounting function is that the costs can be acquired and accounted for in a simple manner without any further credit proof or any failure risk. For example, a rental car operator can process the costs for car use via the system. For this purpose, the customer can put a card into the reading unit and thus pay the fees for car rental. In such a system, one preferably employs so-called pay cards or so-called prepaid cards that perhaps can be acquired from the maker and that then can be used up as in the case of telephone cards.

The reading unit can have either an additional writing function so that, as in the mentioned telephone card, the credit can be reduced in analogy to the costs that were used up. In such a system, one preferably includes the price of gasoline in the costs so that the driver is authorized to gas up free of charge, for example, at a plurality of contract gas stations and so that the car renter does not have to worry about keeping the tank filled up. A rental carmaker thus can release the car in response to the mere submission of an authorization card and need not have to worry about the contract terms or the like. This can make the rental procedure particularly simple and without any additional risk, especially when the car is rented out to company personnel whose company has entered into a general contract with the supplier.

Advantageously, the vehicle owner can determine via the GPS system or the data transmission system where his vehicle is at least at the end of the trip. This facilitates particularly flexible rental of vehicles, in other words, the renter does not return the vehicle but leaves it behind at an agreed-upon area. The vehicle can then be picked up by another renter. In this way, for example, one can effectively handle the rather tight parking spaces in a modern inner city. The city administration or private suppliers can offer a fleet of small cars in the inner city, which, for example, have special parking slots available and that are equipped according to the invention. These vehicles can be released via the credit proof, for example, by inserting a prepaid card or a credit card.

The renter can cover the desired distance within the inner city and then leaves the vehicle at the destination. There it is picked up by another driver, who again leaves it behind someplace else. The car rental operator or owner can monitor the movement of the vehicle with the help of the GPS system and can pick up and bring back, for example, cars that were parked outside the area of the inner city as such. Central data processing here can determine the driver via automatic driver identification and store the data. In a particularly advantageous manner, one also acquires here the clock times and the trip routes so that in the case of traffic violations or accidents involving a hit-and-run situation, the driver can still be determined.

Automatic driver identification makes it possible to check whether the driver has a valid driver's license. This is possible when data protection law provisions so permit, for example, by checking the driver's data against a central card file. Most of the time, however, this will not be possible; in that case, the driver can be given a code carrier that contains his personal data and that is handed out to him after presentation of a driver's license.

It is also possible to combine the card functions. A rental car can be activated via a card that is inserted into the reading unit in one direction and that charges the costs via data transmission against an account. If the card—which, for example, can contain a memory chip —is inserted in another orientation, then the reading unit can charge the costs against a credit account that is stored in the memory chip.

It will be apparent from the foregoing that while particular forms of the invention have been illustrated and described, various modifications can be made without departing from the spirit and scope of the invention. Accordingly, it is not intended that the invention be limited, except as by the appended claims.

What is claimed is:

1. A cost-managed startup system for use in a motor vehicle, the system comprising:
a first data transmission device for transmitting data from the motor vehicle to at least one receiving station, the first data transmission device comprising:
a transmitting function; and
a means for transmitting data from the motor vehicle via the transmitting function to the receiving station in a wireless manner continually or at predetermined intervals where the data can be processed in a central station that is connected with the receiving station;
a means for measuring the distance covered by the motor vehicle;
a second data transmission de/ice that connects the measuring means with the first data transmission device; and
a cost legitimizer comprising a reading unit for accepting credit proof to be submitted by a driver of the motor vehicle where the vehicle is released for startup only after the credit proof has been validated.

2. The system of claim 1 further comprising an automatic driver identification device including an individual coding means or a verification unit into which the driver inputs a personal code.

3. The system of claim 1 wherein the credit proof comprises a credit card for insertion into the reading unit.

4. The system of claim 1 wherein the credit proof comprises a prepaid card with an electronic credit storage arranged thereupon for insertion into the reading unit.

5. The system of claim 4 wherein the reading unit comprises a reading/writing function capable of reading credit memory available on the prepaid card and storing resultant credit diminution upon the prepaid card after deduction of a generated cost.

6. The system of claim 1 and 2 wherein the reading unit comprises the automatic driver identification device.

7. A process for individually acquiring a cost of a trip in a motor vehicle comprising:
determining a distance covered by a driver;
transmitting data comprising the driver's identity and the distance covered by that driver via a first data transmission unit and a second data transmission unit to a receiving station;
transmitting the data from the receiving station to a central station;
processing the data using a data processing unit within the central station;
storing the acquired cost;
deducting the cost from a credit account of the driver; and
making the motor vehicle ready for startup only after the cost has been covered by the driver's credit account.

8. The process of claim 7 wherein the driver of the motor vehicle is identified automatically by a readout of an individual code carrier or by inputting a code.

9. The process of claim 7 wherein the credit account is the credit line of a credit card.

10. The process of claim 7 wherein the credit account is in the form of a prepaid card capable of being read out and written upon by a reading unit.

11. The process of claim 7 wherein the cost determined for the distance covered is transmitted via the first data transmission unit and the receiving station to the data processing unit that manages the credit account in the form of a general availability credit framework that is granted to the driver of the motor vehicle by a person authorized to grant such permission, where the data processing unit deducts the accruing costs from the generally available credit framework.

12. The process of claim 7 wherein the data processing unit is located within a computer that is connected with the receiving station via the Internet.

13. The process of claim 7 wherein the receiving station is a receiving station of a mobile radio network to which are transmitted the data in the form of a data or text communication, therefore making the data or text communication available to the data processing unit via the Internet.
